(19) United States
(12) Patent Application Publication
(10) Pub. No.: US 2016/0070904 A1
(43) Pub. Date: Mar. 10, 2016

(54) ELECTRONIC DEVICE AND METHOD FOR CONTROLLING POSITIONING FUNCTION ACCORDING TO PASSWORD INPUTTED ON USER INTERFACE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: TE-JIA LIU, Shenzhen (CN); CHIH-SAN CHIANG, New Taipei (TW); HAI-SEN LIANG, Shenzhen (CN)

(21) Appl. No.: 14/752,181

(22) Filed: Jun. 26, 2015

(30) Foreign Application Priority Data
Sep. 5, 2014 (CN) 201410451067.7

(51) Int. Cl. G06F 21/45; G06F 21/31

(52) U.S. Cl. CPC G06F 21/45; G06F 21/31

(57) ABSTRACT

An electronic device and positioning control method are provided. Programs in a storage device, executed by at least one processor, cause the at least one processor to display a password inputting interface; recognize an inputted password; determine whether the inputted password matches a preset password stored in the storage device and display a positioning setting interface for enablement or disablement of a positioning device if the inputted password matches the preset password. The method activates the positioning device if an option for enabling the positioning device on the positioning setting interface is selected; and then obtains current positional information of the electronic device if the positioning device is activated.

### CROSS-REFERENCE TO RELATED APPLICATIONS

This application claims priority to Chinese Patent Application No. 201410451067.7 filed on Sep. 5, 2014, the contents of which are incorporated by reference herein.

### FIELD

The subject matter herein generally relates to computing security.

### BACKGROUND

Electronic devices having positioning function are widely used. However, an electronic device cannot determine a current location of itself if the positioning function of the electronic device is disabled.

### BRIEF DESCRIPTION OF THE DRAWINGS

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an embodiment of an electronic device applying a positioning control system.

FIG. 2 shows a user interface for setting a new password displayed on the electronic device of FIG. 1

FIGS. 3 shows a user interface for inputting a password displayed on the electronic device of FIG. 1.

FIG. 4 shows a user interface for setting a positioning function displayed on the electronic device of FIG. 1.

FIGS. 5 shows a user interface for displaying prompt information on the electronic device of FIG. 1.

FIG. 6 is a flowchart of an embodiment of a positioning control method for an electronic device, such as the one of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

The term “module” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic modules, such as gates and flip-flops, and may comprise programmable modules, such as programmable gate arrays or processors. The modules described herein may be implemented as either software and/or hardware modules and may be stored in any type of non-transitory computer-readable storage medium or other computer storage device. Some non-limiting examples of non-transitory computer-readable media include CDs, DVDs, BLUE-RAY, flash memory, and hard disk drives. The term “comprising” means “including, but not necessarily limited to”; it specifically indicates open-ended inclusion or membership in a so-described combination, group, series and the like.

The present disclosure is described in relation to an electronic device and positioning control method. Programs in a storage device, executed by at least one processor, cause the at least one processor to display a password inputting interface for a user to input a password; recognize the inputted password, and determine whether the inputted password matches a preset password stored in the storage device; display a positioning setting interface if the inputted password matches the preset password; activate a positioning device if an option for enabling the positioning device on the positioning setting interface is selected; and obtain current position information of the electronic device if the positioning device is activated.

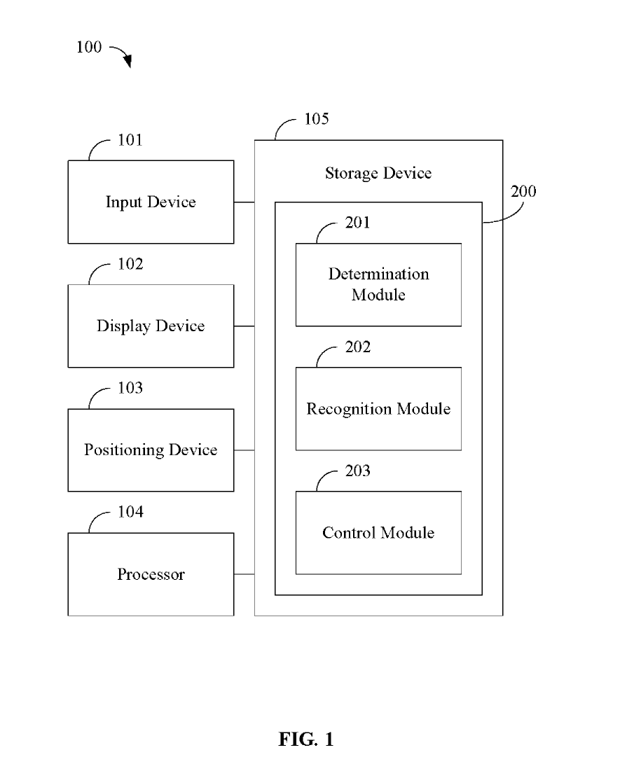

FIG. 1 illustrates an embodiment of an electronic device 100. A positioning control system 200 is applied to the electronic device 100. The electronic device 100 can be a mobile phone or a tablet computer, or other portable device. The electronic device 100 can include an input device 101, a display device 102, and a positioning device 103. The electronic device 100 can also include at least one processor 104 and a storage device 105. In at least one embodiment, the electronic device 100 includes one processor 104. The processor 104 executes instructions of a number of modules stored in the storage device 105. The storage device 105 can store a determination module 201, a recognition module 202, and a control module 203.

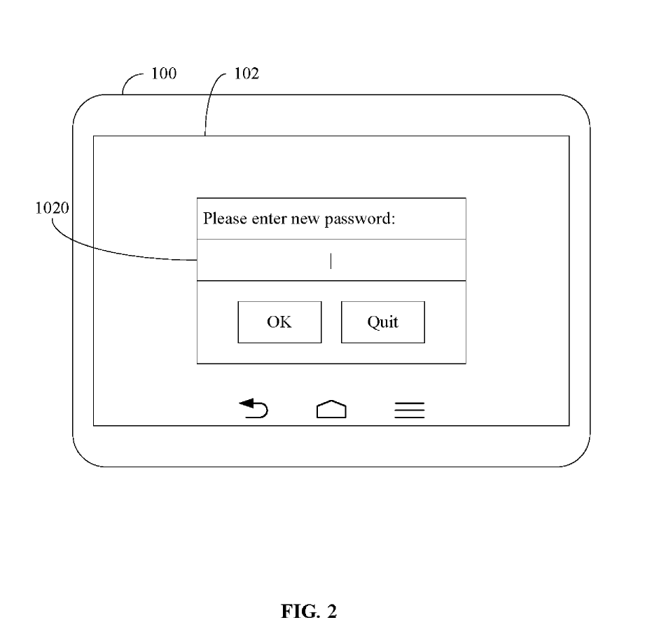

The determination module 201 determines whether the electronic device 100 is being used for the first time when the electronic device 100 is powered on. In at least one embodiment, if there is one password stored in the storage device 105, the determination module 201 determines that the electronic device 100 is not being used for the first time. If there is no password stored in the storage device 105, the determination module 201 determines that the electronic device 100 is being used for the first time, and then the display device 102 displays a password setting interface 1020 as shown in FIG. 2. The recognition module 202 recognizes a user input as a password to be preset, the storage device 105 stores the user input as a preset password. In at least one embodiment, the preset password can be a character password, a voiceprint password, or a fingerprint password.

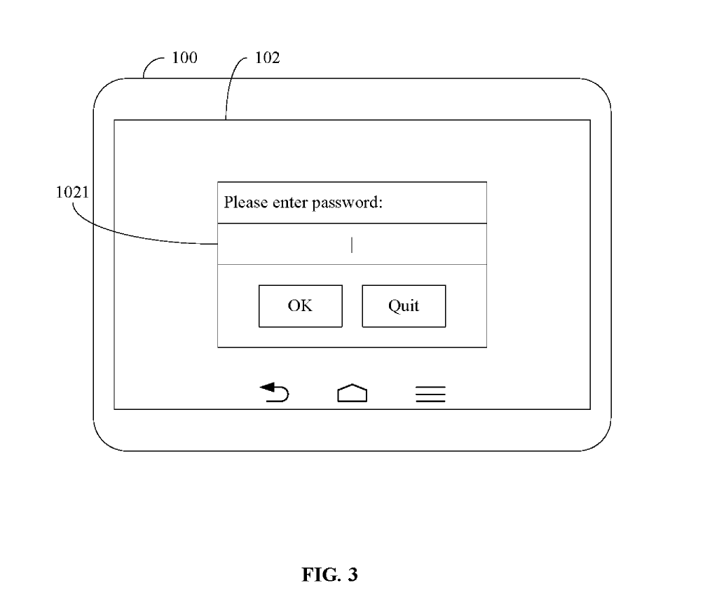

Referring to FIG. 3, the display device 102 displays a password inputting interface 1021. The recognition module 202 recognizes a password inputted by the user and determines whether the inputted password matches the preset password stored in the storage device 105.

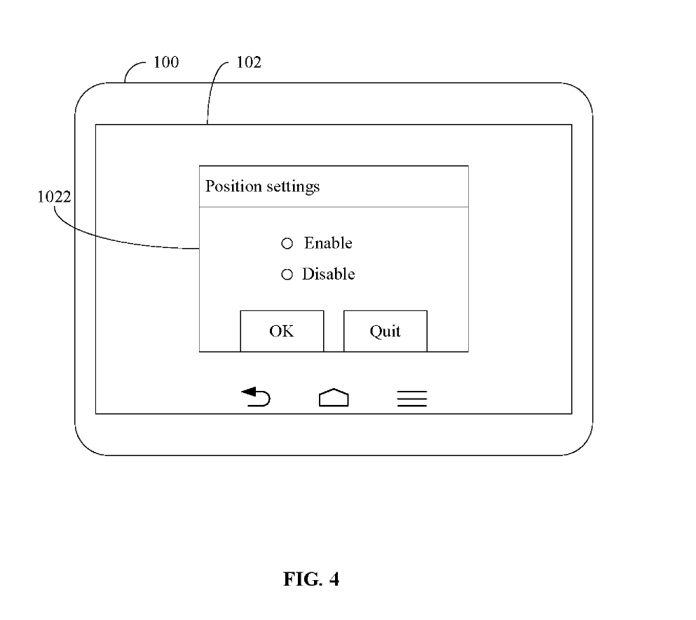

Referring to FIG. 4, the display device 102 displays a positioning setting interface 1022 if the inputted password matches the preset password. The control module 203 determines whether an option for enabling the positioning device 103 is selected. If the option for enabling the positioning device 103 is selected, the control module 203 activates the positioning device 103. If an option for disabling the positioning device 103 is selected, the control module 203 disables the positioning device 103. The positioning device 103 can obtain current positional information of the electronic device 100 if the positioning device 103 is activated. In at least one embodiment, the positioning device 103 is a GPS (Global Positioning System) device.

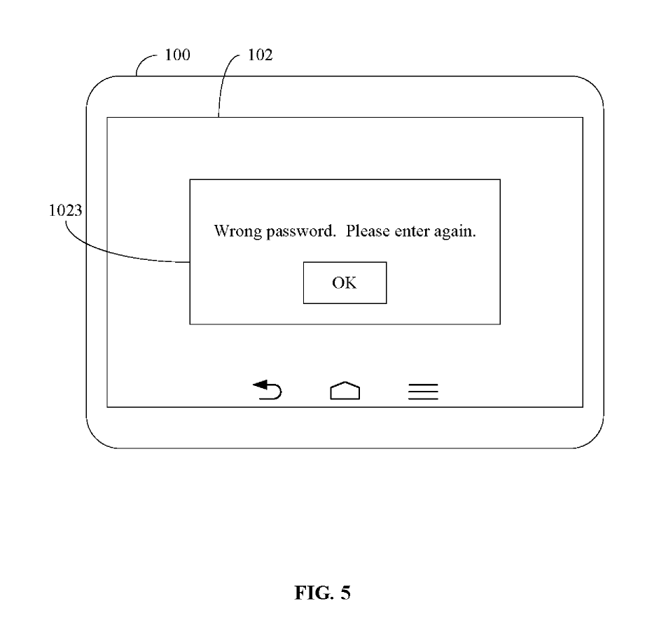

Referring to FIG. 5, the display device 102 displays prompt information 1023 to indicate that the inputted password is wrong if the inputted password is not the same as the preset password.

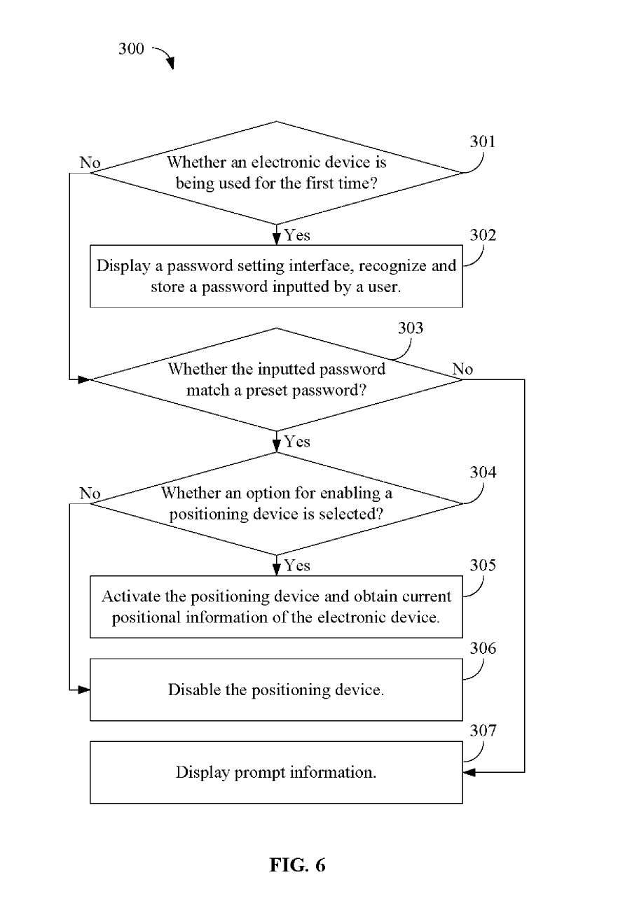

Referring to FIG. 6, a flowchart is presented in accordance with an example embodiment. A method 300 is provided by way of example, as there are varieties of ways to carry out the method. The method 300 described below can be carried out using the configurations illustrated in FIG. 1 and various elements of these figures are referenced in explaining example method 300. Each block shown in FIG. 6 represents one or more processes, methods, or routines, carried out in the exemplary method 300.

Additionally, the illustrated order of blocks is by example only and the order of the blocks can be changed. The exemplary method 300 can begin at block 301.

At block 301, a determination module determines whether an electronic device is being used for the first time when the electronic device is powered on. In at least one embodiment, if there is one password is stored in a storage device, the determination module determines that the electronic device is not being used for the first time, and block 303 is implemented. If there is no password stored in the storage device, the determination module determines that the electronic device is being used for the first time, and block 302 is implemented.

At block 302, a display device displays a password setting interface. A recognition module recognizes a user input as a password to be preset, and the storage device stores the user input as a preset password. In at least one embodiment, the preset password can be a character password, a voiceprint password, or a fingerprint password.

At block 303, the display device displays a password inputting interface. The recognition module recognizes a password inputted by the user and determines whether the inputted password matches the preset password stored in the storage device. If the inputted password matches the preset password, block 304 is implemented. If the inputted password is not the same as the preset password, block 307 is implemented.

At block 304, the display device displays a positioning setting interface. A control module determines whether an option for enabling a positioning device is selected based on an operation of the user. If the option for enabling the positioning device is selected, block 305 is implemented. If an option for disabling the positioning device is selected, block 306 is implemented.

At block 305, the control module activates the positioning device and the positioning device obtains current positional information of the electronic device if the positioning device is activated. In at least one embodiment, the positioning device is a GPS (Global Positioning System) device.

At block 306, the control module disables the positioning device.

At block 307, the display device displays prompt information to indicate that the inputted password is wrong, and the process goes back to block 303.

The embodiments shown and described above are only examples. Many details are often found in the art such as the other features of an electronic device and method for controlling positioning function according to password inputted on user interface. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims.

What is claimed is:

1. An electronic device comprising:
at least one processor;
a non-transitory storage device coupled to the at least one processor and storing one or more programs, which when executed by the at least one processor, cause the at least one processor to:
display a password inputting interface;
recognize an inputted password;
determine whether the inputted password matches a preset password stored in the storage device;
display a positioning setting interface if the inputted password matches the preset password;
activate a positioning device if an option for enabling the positioning device on the positioning setting interface is selected; and
obtain current positional information of the electronic device if the positioning device is activated.

2. The electronic device of claim 1, wherein the one or more programs cause the at least one processor to further:
determine whether the electronic device is being used for the first time; and
display a password setting interface for setting the preset password if the electronic device is being used for the first time.

3. The electronic device of claim 2, wherein the one or more programs cause the at least one processor to further:
display the password inputting interface if the electronic device is not being used for the first time.

4. The electronic device of claim 2, wherein in “determine whether the electronic device is being used for the first time”, the one or more programs cause the at least one processor to further:
determine that the electronic device is being used for the first time if no password is stored in the storage device; and
determine that the electronic device is not the being used for the first time if there is one password stored in the storage device.

5. The electronic device of claim 1, wherein the one or more programs cause the at least one processor to further:
display prompt information to indicate that the inputted password is wrong if the inputted password is not the same as the preset password.

6. A computer-based method for controlling positioning for an electronic device being executed by at least one processor of the electronic device, the method comprising:
displaying a password inputting interface;
recognizing an inputted password;
determining whether the inputted password matches a preset password stored in the storage device;
displaying a positioning setting interface if the inputted password matches the preset password;
activating a positioning device if an option for enabling the positioning device is selected on the positioning setting interface; and
obtaining current positional information of the electronic device if the positioning device is activated.

7. The method of claim 6, wherein the method comprising:
determining whether the electronic device is being used for the first time; and
displaying a password setting interface for setting the preset password if the electronic device is being used for the first time.

8. The method of claim 7, wherein the method comprising:
displaying the password inputting interface if the electronic device is not being used for the first time.

9. The method of claim 7, wherein in “determining whether the electronic device is being used for the first time”, the method comprising:
determining that the electronic device is being used for the first time if no password is stored in the storage device; and
determining that the electronic device is not being used for the first time if there is one password stored in the storage device.

10. The method of claim 6, wherein the method comprising:
displaying prompt information to indicate that the inputted password is wrong if the inputted password is not the same as the preset password.

11. A non-transitory storage device having stored thereon instructions that, when executed by a processor of an electronic device, causes the processor to perform a positioning control method, wherein the method comprises:
displaying a password inputting interface;
recognizing an inputted password;
determining whether the inputted password matches a preset password stored in the storage device;
displaying a positioning setting interface if the inputted password matches the preset password;
activating a positioning device if an option for enabling the positioning device is selected on the positioning setting interface; and
obtaining current positional information of the electronic device if the positioning device is activated.

12. The non-transitory storage device according to claim 11, wherein the method comprising:
determining whether the electronic device is being used for the first time; and
displaying a password setting interface for setting the preset password if the electronic device is being used for the first time.

13. The non-transitory storage device according to claim 12, wherein the method comprising:
displaying the password inputting interface if the electronic device is not being used for the first time.

14. The non-transitory storage device according to claim 12, wherein in “determining whether the electronic device is being used for the first time”, the method comprising:
determining that the electronic device is being used for the first time if no password is stored in the storage device; and
determining that the electronic device is not being used for the first time if there is one password stored in the storage device.

15. The non-transitory storage device according to claim 11, wherein the method comprising:
displaying prompt information to indicate that the inputted password is wrong if the inputted password is not the same as the preset password.
